(19) United States
(12) Patent Application Publication
(10) Pub. No.: US 2016/0177209 A1
(43) Pub. Date: Jun. 23, 2016

(54) ADDITION OF CLAY AND SLAG TO COAL-FIRED COMBUSTORS

(71) Applicant: Ash Improvement Technology Inc., New York, NY (US)

(72) Inventor: Wayne Fried, Maspeth, NY (US)

(21) Appl. No.: 15/053,917

(22) Filed: Feb. 25, 2016

Related U.S. Application Data
(63) Continuation-in-part of application No. 14/880,996, filed on Oct. 12, 2015.
Application No. 14/880,996 is a continuation-in-part of application No. 13/741,071, filed on Jan. 14, 2013, now abandoned.
Application No. 13/741,071 is a continuation-in-part of application No. 12/889,100, filed on Sep. 23, 2010, now Pat. No. 8,741,054.
(60) Provisional application No. 61/245,594, filed on Sep. 24, 2009.
(60) Provisional application No. 62/062,442, filed on Oct. 10, 2014.
(60) Provisional application No. 62/120,741, filed on Feb. 25, 2015.

(51) Int. Cl. C10L 10/02; C04B 18/06; F23K 1/00; C10L 5/04

(52) U.S. Cl. CPC C10L 10/02; C10L 5/04; C04B 18/065; F23K 1/00; C10L 2200/0272; C10L 2200/024; F23K 2201/505

(57) ABSTRACT

Clay and slag additions are made during coal combustion processes to reduce unwanted emissions such as SO₂, NOₓ and mercury. The clay additives may include kaolin. The slag additives may include stainless steel slag. The resultant combustion products may be used as cement additives.

### CROSS-REFERENCE TO RELATED APPLICATIONS

This application is a continuation-in-part of U.S. patent application Ser. No. 14/880,996 filed Oct. 12, 2015, which is a continuation-in-part of U.S. patent application Ser. No. 13/741,071 filed Jan. 14, 2013, which is a continuation-in-part of U.S. patent application Ser. No. 12/889,100 filed Sep. 23, 2010, now U.S. Pat. No. 8,741,054 issued Jun. 3, 2014, which claims the benefit of U.S. Provisional Patent Application Ser. No. 61/245,594 filed Sep. 24, 2009. U.S. patent application Ser. No. 14/880,996 also claims the benefit of U.S. Provisional Patent Application Ser. No. 62/062,442 filed Oct. 10, 2014. This application also claims the benefit of U.S. Provisional Patent Application Ser. No. 62/120,741 filed Feb. 25, 2015. All of these applications are incorporated herein by reference.

### FIELD OF THE INVENTION

The present invention relates to the addition of clay and slag materials during coal combustion processes to reduce unwanted emissions and to produce combustion products that may be used as cement additives.

### BACKGROUND INFORMATION

U.S. Pat. No. 8,741,054 and Published U.S. Application Nos. US2013/0125791, US2013/0125792, US2013/0125799 and US2016/0031758, which are incorporated herein by reference, disclose coal combustion processes, such as those used in coal-fired electrical power generation plants, in which additives are introduced during the process to produce combustion products having beneficial properties when they are used as additives to cementitious materials.

### SUMMARY OF THE INVENTION

An aspect of the present invention is to provide a method of reducing emissions during coal combustion processes comprising combusting the coal in the presence of a clay additive and a slag additive, wherein the combined weight of the clay additive and the slag additive is at least 8 weight percent of the weight of the coal.

Another aspect of the present invention is to provide a method of reducing emissions during coal combustion processes comprising combusting the coal in the presence of a kaolin additive and a stainless steel slag additive, wherein the combined weight of the kaolin additive and the stainless steel slag additive is from 2 to 60 weight percent of the weight of the coal.

These and other aspects of the present invention will be more apparent from the following description.

### BRIEF DESCRIPTION OF THE DRAWINGS

FIG. 1 schematically illustrates methods of adding clay and slag separately to coal combustion processes to reduce emissions and produce a combustion product in accordance with an embodiment of the present invention.

FIG. 2 schematically illustrates methods of adding clay and slag together to coal combustion processes to reduce emissions and produce a combustion product in accordance with an embodiment of the present invention.

FIG. 3 is a graph of SO₂ emissions and limestone addition rates during operation of a coal fired boiler, including test periods during which clay and slag additions were made, in accordance with an embodiment of the present invention.

FIG. 4 is a graph of steam flow during operation of the coal fired boiler corresponding to FIG. 3.

FIG. 5 is a graph of coal flow rate during operation of the coal fired boiler corresponding to FIG. 3.

FIG. 6 is a graph of NO emissions during a portion of the operation of the coal fired boiler corresponding to FIG. 3.

FIG. 7 is a graph of slag additions during a first test period of the coal fired boiler corresponding to FIG. 3.

FIG. 8 is a graph of kaolin addition rates during the first test period of the coal fired boiler corresponding to FIG. 3.

FIG. 9 is a graph of slag addition rates during a second test period of the coal fired boiler corresponding to FIG. 3.

FIG. 10 is a graph of kaolin addition rates during the second test period of the coal fired boiler corresponding to FIG. 3.

FIG. 11 is a graph of slag addition rates during a third test period of the coal fired boiler corresponding to FIG. 3.

FIG. 12 is a graph of kaolin addition rates during the third test period of the coal fired boiler corresponding to FIG. 3.

### DETAILED DESCRIPTION

In accordance with the present invention, clay, such as kaolin, and slag, such as stainless steel furnace slag, are added to coal-fired combustors to reduce emissions such as SO₂, NO and heavy metals such as mercury. The resultant material byproduct of the combustion process may be used as an additive for cementitious materials, with enhanced pozzolanic reactivity, water reducing capabilities, and other benefits, such as alkali-silica reaction inhibition.

In accordance with embodiments of the present invention, the clay and slag additives are introduced during a coal combustion process, such as the fluidized bed combustion zone of a coal-fired power plant. They can also be injected into other conventional boilers such as pulverized combustion (PC) boilers. Although the clay and slag may be introduced directly into the burner in one embodiment of the invention, alternative embodiments include introducing upstream from the burner and/or downstream from the burner. When introduced upstream, the clay and slag additives may be introduced separately into a coal stream, or may be pre-mixed together before their addition to the coal stream. When introduced directly into the combustion chamber, the clay and slag may be introduced separately, pre-mixed and introduced together and/or pre-mixed with the coal. When introduced downstream, the clay and slag may be introduced separately or together.

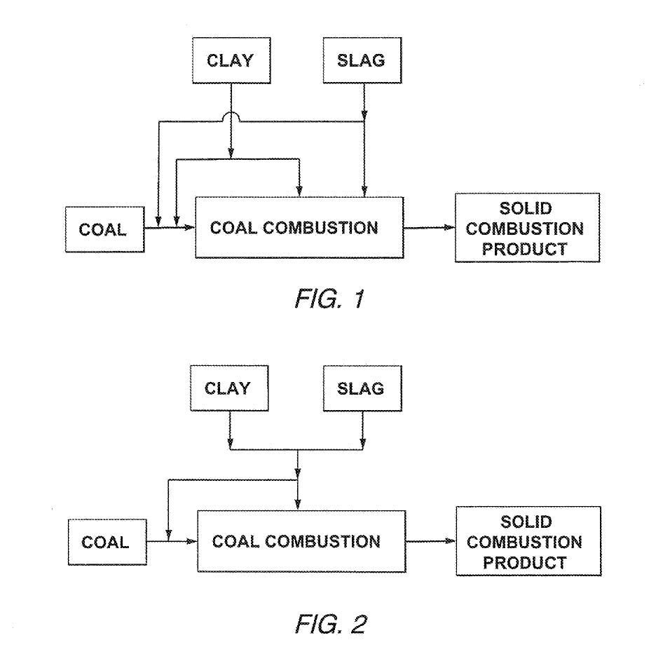

FIGS. 1 and 2 schematically illustrate processes for reducing unwanted emissions and producing combustion products that may be used as pozzolanic materials for use in cement in accordance with embodiments of the present invention. The clay and slag additions are introduced during the coal combustion processes. In the embodiments of FIG. 1, the clay and slag additives are introduced separately during the coal combustion process. In the embodiments of FIG. 2, the clay and slag additives are introduced together into the coal combustion process.

As shown in FIG. 1, the clay additive may be added directly into the coal combustion zone, such as the burner of a coal-fired electric power generating plant. Alternatively, the clay additive may be mixed with the coal prior to their introduction into the coal combustion zone. As also shown in FIG. 1, the slag additive may be added directly into the coal combustion zone. Alternatively, the slag additive may be mixed with the coal prior to their introduction into the coal combustion zone. When the clay and/or slag are introduced into the coal combustion zone, they may be introduced in any suitable manner, for example, by a direct feed line into the burner. In certain embodiments, the clay and/or slag additives are introduced into a recirculation loop that feeds back into the burner.

The embodiments shown in FIG. 2 are similar to those of FIG. 1, with the exception that the clay additive and the slag additive are mixed or otherwise combined together prior to their introduction into the coal combustion zone or their pre-mixture with the coal prior to introduction into the coal combustion zone. In certain embodiments, the clay additive and slag additive are introduced into a recirculation loop that feeds back into the burner.

Thus, in accordance with embodiments of the present invention as illustrated in FIGS. 1 and 2, clay and slag additives are introduced during a coal combustion process, such as the combustion zone of a coal-fired power plant. The clay and slag additives may be introduced into the burner, upstream from the burner and/or downstream from the burner in a recirculation loop back into the burner. When introduced upstream, the clay and slag additives may be introduced separately into a coal stream, or may be pre-mixed together before their addition to the coal stream. When introduced directly into the combustion chamber, the clay and slag may be introduced separately, pre-mixed and introduced together and/or pre-mixed with the coal.

Any suitable type or grade of coal may be used in accordance with the present invention. In certain embodiments, the coal that is introduced into the burner may be low-grade coal, e.g., comprising waste or a by-product such as coal washings from coal processing operations. Such coal washings are considered waste material that may be stored in large outdoor heaps or piles, which can result in unwanted water contamination and runoff in the surrounding areas, e.g., the water may have a pH as low as 1. Certain types of power plants burn such coal washings as waste materials and may therefore be classified as waste treatment plants rather than conventional coal-fired power plants. All of these types of facilities are considered to be within the scope of the present invention, as well as other coal combustion facilities and processes.

In accordance with embodiments of the invention, the clay additive comprises kaolin. The kaolin group has three members (kaolinite, dickite and nacrite) and a formula of Al₂Si₂O₅(OH)₄. For example, kaolin may include about 46 weight percent silica and about 28 weight percent alumina, with minor amounts of titanium (e.g., 1.5 weight percent), iron (e.g., 0.62 weight percent), calcium (e.g., 0.19 weight percent), magnesium (e.g., 0.14 weight percent), carbon (e.g., 0.01 weight percent) and sulfur trioxide (e.g., 0.02 weight percent), along with minor amounts of moisture. The different minerals are polymorphs, meaning that they have the same chemistry but different structures (polymorph=many forms). The general structure of the kaolinite group is composed of silicate sheets (Si₂O₅) bonded to aluminum oxide/hydroxide layers (Al₂(OH)₄) called gibbsite layers. The silicate and gibbsite layers are tightly bonded together with only weak bonding existing between the s-g paired layers.

Other examples of clay additives that may be used as partial or total replacements for kaolin include montmorillonite/smectite, illite and chlorite groups.

The montmorillonite/smectite group is composed of several minerals including pyrophyllite, talc, vermiculite, sauconite, saponite, nontronite and monmorillonite. They differ mostly in chemical content. The general formula is (Ca, Na, H)(Al, Mg, Fe, Zn)₂(Si, Al)₄O₁₀(OH)₂-xH₂O, where x represents the variable amount of water that members of this group could contain. Talc's formula, for example, is Mg₃Si₄O₁₀(OH)₂. The gibbsite layers of the kaolinite group can be replaced in this group by a similar layer that is analogous to the oxide brucite, (Mg₂(OH)₄). The structure of this group is composed of silicate layers sandwiching a gibbsite (or brucite) layer in between, in an s-g-s stacking sequence. The variable amounts of water molecules would lie between the s-g-s sandwiches.

The illite group is basically a hydrated microscopic muscovite. The mineral illite is the only common mineral represented, however it is a significant rock forming mineral being a main component of shales and other argillaceous rocks. The general formula is (K, H)Al₂(Si, Al)₄O₁₀(OH)₂-xH₂O, where x represents the variable amount of water that this group could contain. The structure of this group is similar to the montmorillonite group with silicate layers sandwiching a gibbsite-like layer in between, in an s-g-s stacking sequence. The variable amounts of water molecules would lie between the s-g-s sandwiches as well as the potassium ions.

The chlorite general formula is X₄₋₆Y₄O₁₀(OH, O)₈. The X represents one or more of aluminum, iron, lithium, magnesium, manganese, nickel, zinc or rarely chromium. The Y represents either aluminum, silicon, boron or iron but mostly aluminum and silicon.

The kaolin or other clay additives typically comprise from 1 or 2 to 50 percent of the weight of the coal, for example, from 3 to 30 weight percent. In certain embodiments, the kaolin may comprise at least 5 weight percent, or at least 6 or 8 weight percent. The average particle size of the kaolin may typically be above 3 microns. In certain embodiments, the average particle size of the kaolin may be from 1 to 10 microns. The moisture content of the kaolin may also range from 1 to 10%.

In certain embodiments, the clay additive may include particle size fractions that are not typically desirable for certain types of industrial applications such as use in paper or cosmetic products. For example, the kaolin may have a smaller and/or larger average particle size than the kaolin typically used in various industries. As a particular example, when kaolin is mined, approximately one-third may be sized appropriately and of the proper chemical composition for use in the paper or cosmetic industries, while the remaining approximately two-thirds of the mined kaolin may include ultrafine particles, coarse particles or particles that are outside of the chemical specification for those uses. These materials may remain unused. Such unused fractions may be dumped into storage areas such as pits, abandoned mines, etc. In accordance with embodiments of the present invention, such discarded kaolin is useful as the kaolin additive component in the coal combustion process.

In accordance with another embodiment of the invention, recycled kaolin or other clays from various sources such as waste paper may be recovered and used as the clay additive in accordance with the present invention. In certain instances, such as waste paper containing clay, the entire waste product may be combusted in the burner, thereby providing a source of clay as well as an additional combustible fuel for the combustion process.

The slag additive may include stainless steel furnace slag, basic oxygen slag (BOS), electric arc furnace (EAF) slag, aluminum slag, copper slag, magnesium slag, argon oxygen decarburization (AOD) slag, austenitic steel slag, ladle slag, and the like. As understood by those skilled in the art, such types of slag are produced during specified metallurgical processing, e.g., stainless steel slag is produced as a by-product of the stainless steel making process.

The stainless steel slag additive, or other slag additive, typically comprises from 1 or 2 to 50 percent of the weight of the coal, for example, from 3 to 30 weight percent. In certain embodiments, the stainless steel slag may comprise at least 5 weight percent, or at least 6 or 8 weight percent. Although combined additions of clay and slag are primarily described herein, addition of only one of clay and slag may be used, for example, stainless steel slag may be added without the clay in the amounts described above. The average particle size of the stainless steel furnace slag may typically be above 10 microns, for example, from 10 microns to 2 mm. However, in certain embodiments, fine stainless steel slag having an average particle size less than 10 microns may be used.

When used together, the total combined weight of the clay and slag is typically from 8 to 60 percent of the weight of the coal, for example, from 8 to 40 or 50 weight percent. However, in certain embodiments, the combined weight of the clay and slag may be less than 8 weight percent, for example, a minimum of 6 weight percent, or a minimum of 4 weight percent, or a minimum of 2 weight percent, e.g., the combined weight of the clay and slag may range from 2 to 60 weight percent, or from 4 or 5 weight percent to 40 or 50 weight percent.

Other optional additives include limestone, alumino-silicate minerals, waste concrete such as recycled Portland cement concrete, shale, recycled crushed glass, recycled crushed aggregate fines, silica fume, cement kiln dust, lime kiln dust, weathered clinker, clinker, granite kiln dust, zeolites, limestone quarry dust, red mud, fine ground mine tailings, oil shale fines, bottom ash, dry stored fly ash, landfilled fly ash, ponded flyash, lithium-containing ores and other waste or low-cost materials containing calcium oxide, silicon dioxide and/or aluminum oxide.

In certain embodiments, limestone may be injected along with the clay and slag additives during the coal combustion process. The amount of limestone may be selected in order to control emissions such as SO_{X} while producing a combustion product with desirable properties when added to cement. For example, the amount of limestone may range from zero to 5 weight percent based on the weight of the coal, or the limestone may range from 0.5 to 4 weight percent, or from 1 to 3 weight percent, based on the weight of the coal. When limestone, clay additives and slag additives are injected during the coal combustion process, their combined weight is typically at least 8 weight percent based on the total weight of the coal, limestone, clay and slag, for example, their combined weight may be at least 10 weight percent based on the total weight of the coal, limestone, clay and slag.

In certain embodiments, water may be added, e.g., either separately from the additives or as part of the moisture content of at least one of the additives. For example, steam at a pressure up to 200 psi may be added. Alternatively, water may be added as part of a slurry containing the clay and/or slag additives. A typical slurry may contain any suitable amount of water, e.g., from 0.5 or 1 weight percent to 10 or 20 weight percent, or more, with the balance being solids (clay and/or slag). In certain embodiments, the amount of water versus coal may typically range from zero up to 3 percent or more based upon the weight of the coal.

In accordance with embodiments of the present invention, unwanted emissions are significantly reduced during coal combustion processes, i.e., the amount of a particular emission is reduced by a substantial percentage when the clay and slag additives are added during a coal combustion process in comparison with the same coal combustion process without the additives. For example, SOₓ emissions may be reduced by at least 10%, or at least 20%, or at least 50%, or more. NOₓ emissions may be reduced by at least 10%, or at least 20%, or at least 25%, or more. Mercury emissions may be reduced by at least 10%, or at least 20%, or at least 30%, or at least 40%, or more.

The combustion products of the present invention may be added to various types of cement, including Portland cement. For example, the combustion products may comprise greater than 10 weight percent of the cementitious material, typically greater than 25 weight percent. In certain embodiments, the additive comprises 30 to 95 weight percent of the cementitious material.

One embodiment of the present invention uses the coal fired boiler of an electric power plant as a chemical processing vessel to produce the combustion products, in addition to its normal function of generating steam for electrical energy. This approach may be taken without reducing the efficiency of the boiler's output while, at the same time, producing a commodity with a controlled specification and a higher commercial value to the construction market. The resulting ash product is designed to have beneficial pozzolanic properties for use in conjunction with Portland cement, or with different chemical modifications also producing a pozzolan that could also be a direct substitution for Portland cement. In both cases, advantages may be both economic and environmental. Landfill needs are reduced, and cost savings result by avoiding transportation and land filling of the ash. In addition, to the extent that the ash replaces Portland cement, it reduces the amount of carbon dioxide and other toxic emissions generated by the manufacture of Portland cement.

The following examples are intended to illustrate various aspects of the present invention, and are not intended to limit the scope of the invention.

### Example 1

Mercury emission tests were performed during operation of a conventional fluidized bed coal fired boiler of an electrical power generation plant. Test Material A comprised coal with limestone injections. Test Material B comprised coal with clay injections. Test Material C comprised coal with combined slag and clay injections in which the clay was present in a relatively small amount. Test Material D comprised coal with slag and clay injections in which the clay was present in a relatively large amount. Table 1 provides mercury capture test results. The combined slag and clay injections significantly reduced mercury levels.

TABLE 1
Combustion Fluidized Bed Injection Testing-Mercury Emissions

| | | | | | % |
|---|---|---|---|---|---|
| | lbs/ | | lbs/ | % of | Annual |
| Material | MMBtu | lbs/TBtu | GWh | Allowable | Average |
| Test Material A | 3.27E−08 | 3.27E−02 | 4.39E−04 | 2.73% | 27.25% |
| Test Material B | 3.10E−08 | 3.10E−02 | 4.02E−04 | 2.58% | 25.83% |
| Test Material C | 1.36E−08 | 1.36E−02 | 1.78E−04 | 1.13% | 11.33% |
| Test Material D | 2.12E−08 | 2.12E−02 | 2.80E−04 | 1.77% | 17.67% |

### Example 2

Tests were performed in a conventional fluidized bed coal fired boiler of an electrical power generation plant. Combined injections of clay and slag were made to the coal combustion zone by adding the clay and slag into the recirculation loop of the fluidized bed boiler. The clay additive comprised kaolin, while the slag additive comprised stainless steel slag.

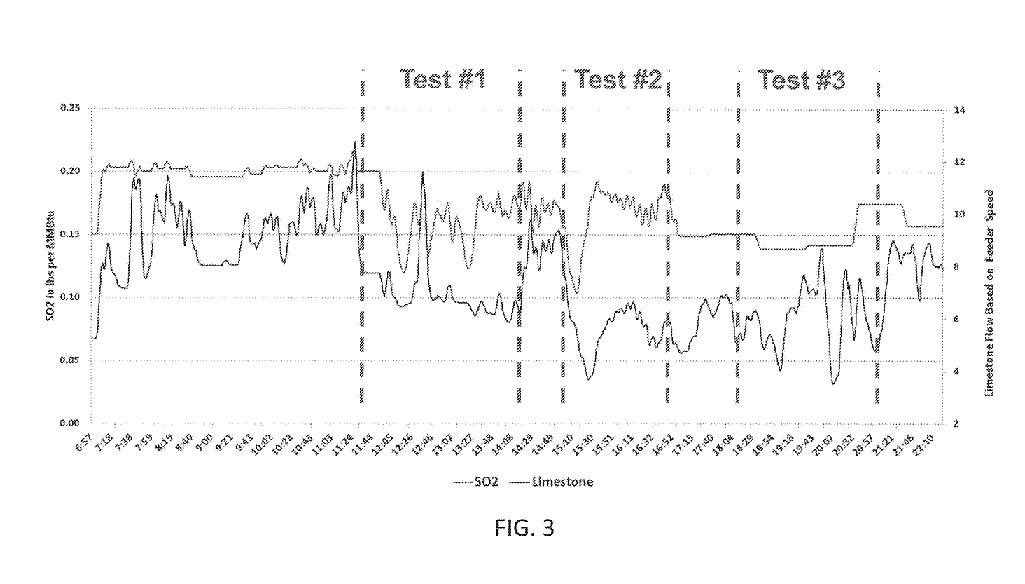

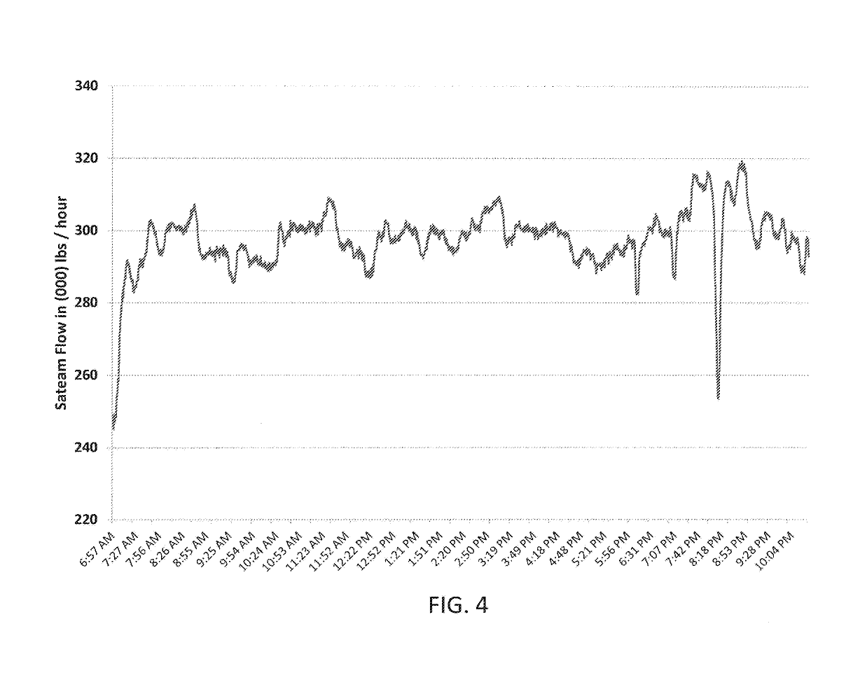

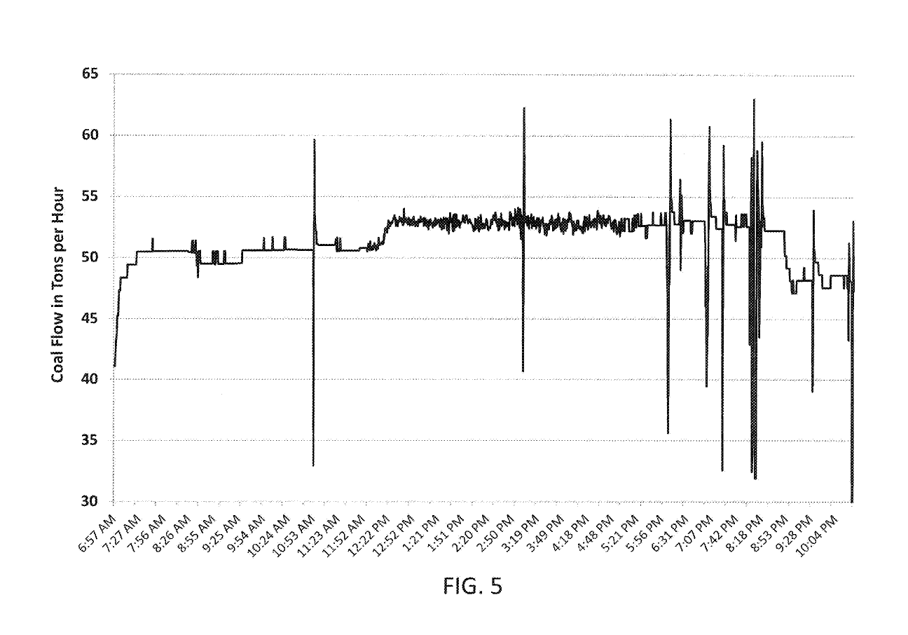

Results of the tests are illustrated in FIGS. 3-12. FIG. 3 includes plots of SO₂ emissions and limestone additions during three test periods labeled as Test #1, Test #2 and Test #3. Steam flow and coal addition rates during the time periods shown in FIG. 3 are plotted in FIGS. 4 and 5.

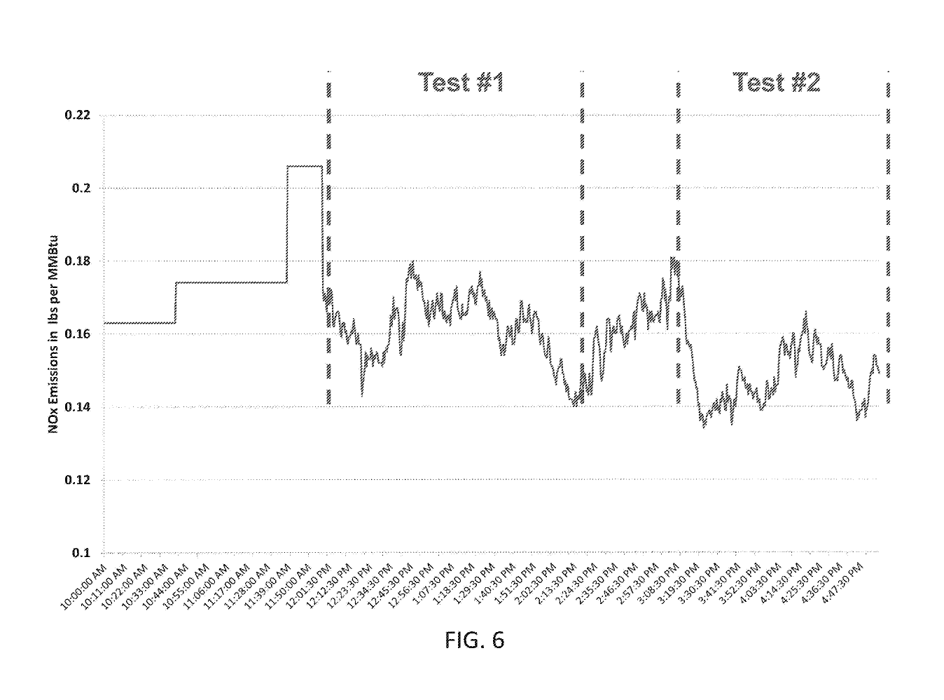

FIG. 6 shows NOₓ emissions during the Test #1 and Test #2 periods.

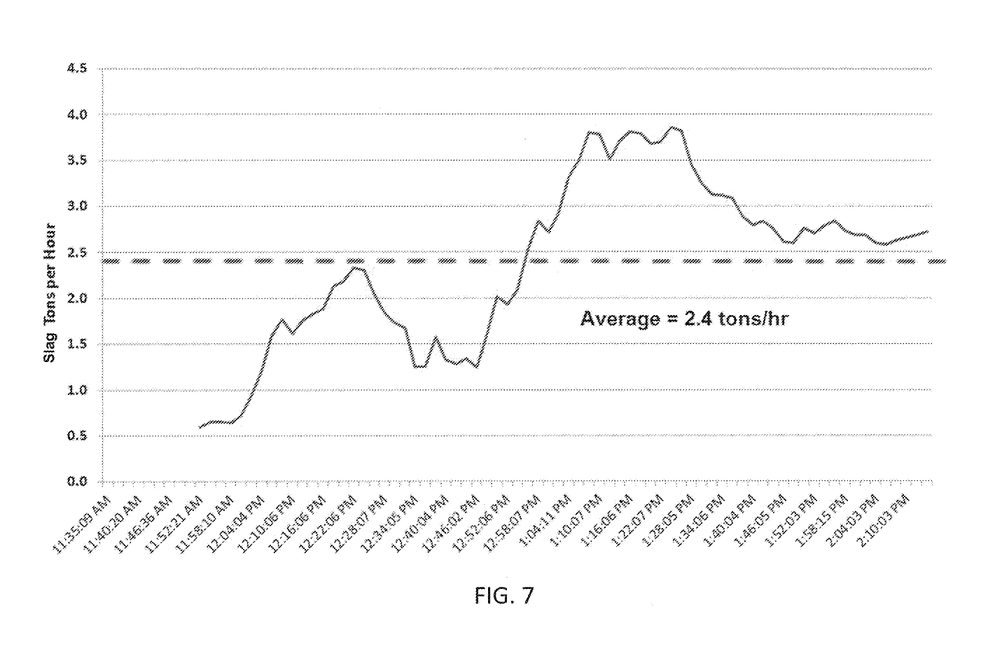

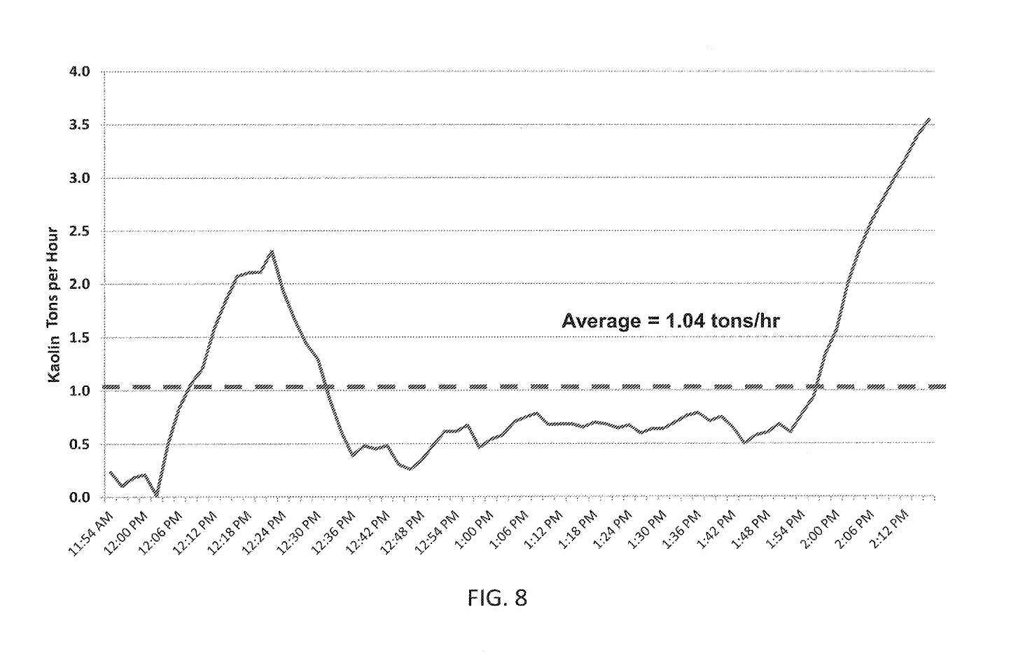

FIG. 7 shows moving average slag addition rates during the Test #1 period. FIG. 8 shows moving average kaolin addition rates during the Test #1 period.

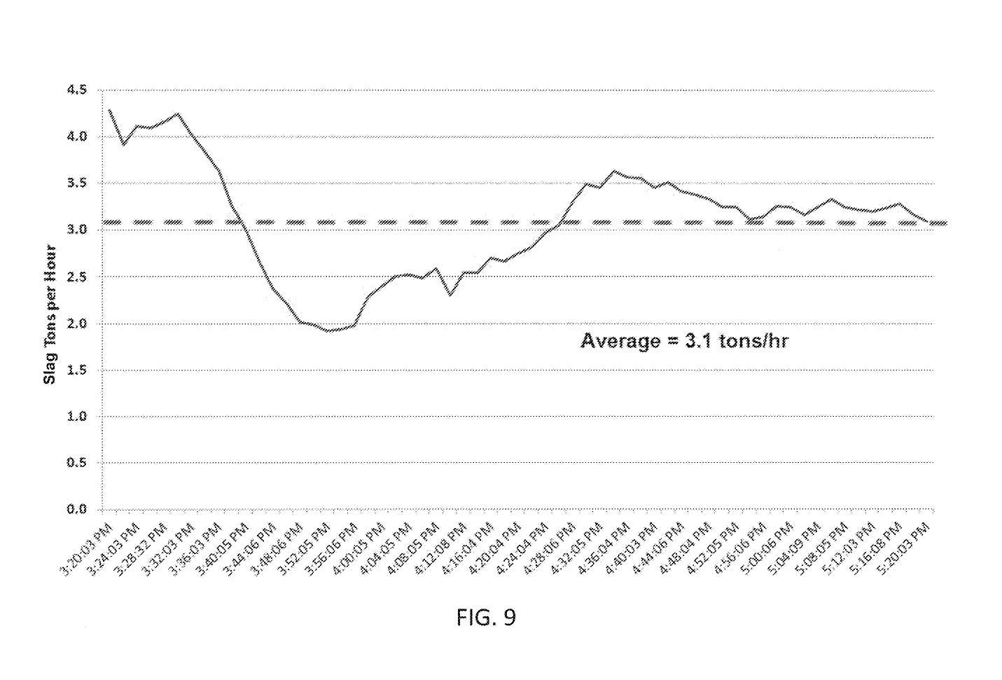

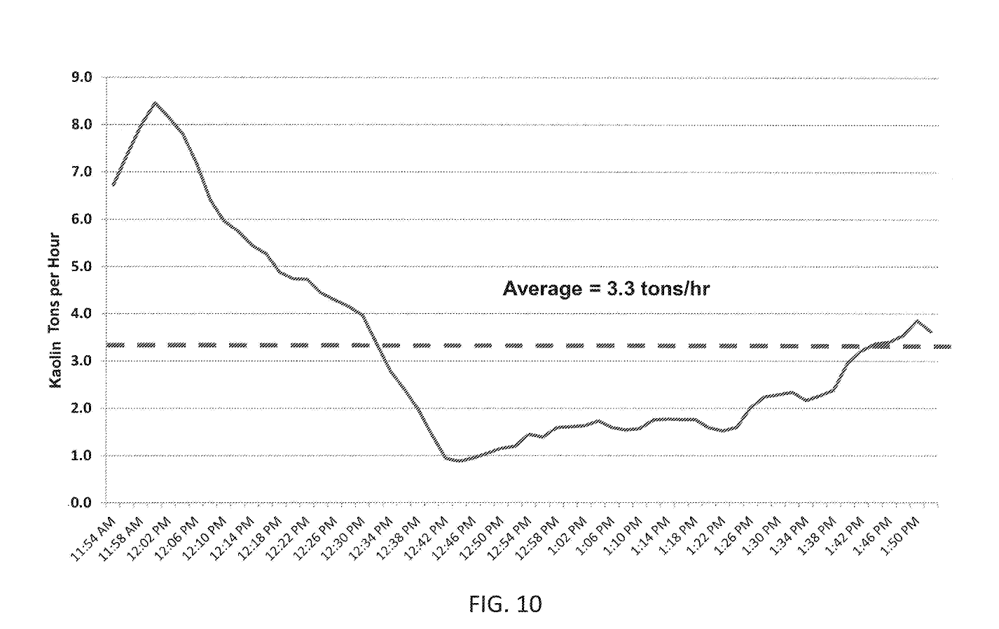

FIG. 9 shows moving average slag addition rates during the Test #2 period. FIG. 10 shows moving average kaolin addition rates during the Test #2 period.

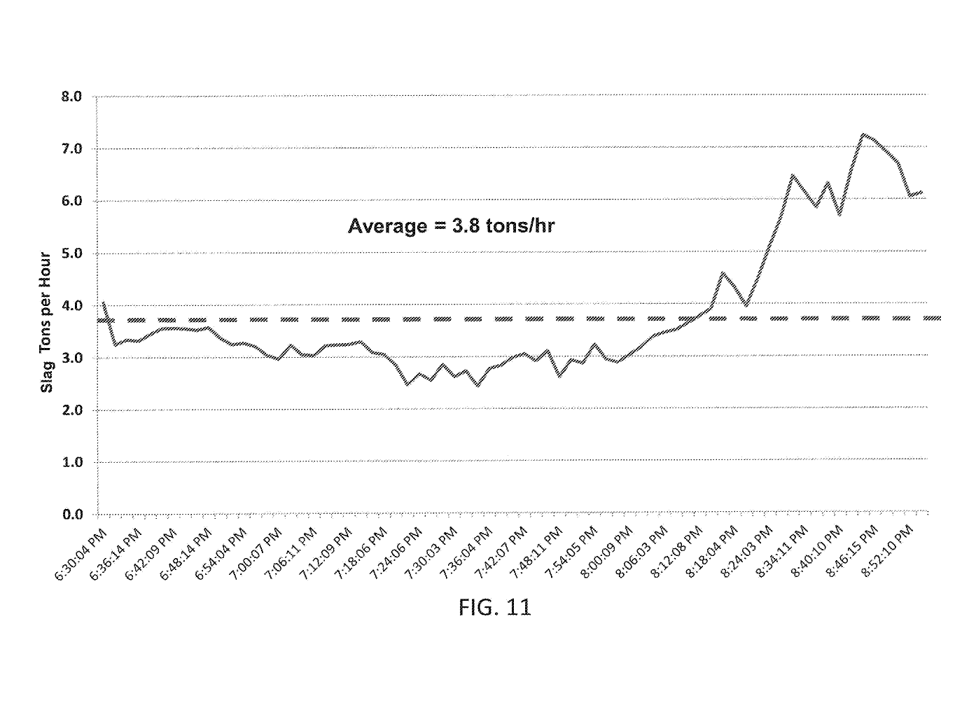

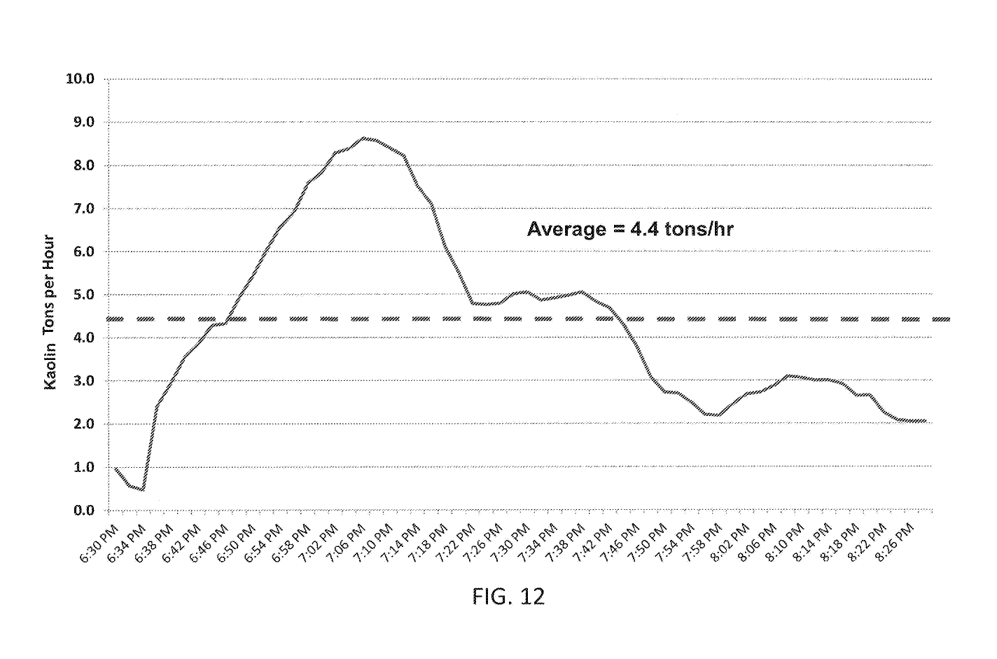

FIG. 11 shows moving average slag addition rates during the Test #3 period. FIG. 12 shows moving average kaolin addition rates during the Test #3 period.

The data shown in FIGS. 3-12 demonstrates that SO₂ and NOₓ emissions are significantly reduced during the periods when kaolin and stainless steel slag additions were made to the coal fired boiler.

Whereas particular embodiments of this invention have been described above for purposes of illustration, it will be evident to those skilled in the art that numerous variations of the details of the present invention may be made without departing from the invention as defined in the appended claims.

What is claimed is:

1. A method of reducing emissions during coal combustion processes comprising combusting the coal in the presence of a clay additive and a slag additive, wherein the combined weight of the clay additive and the slag additive is at least 8 weight percent of the weight of the coal.

2. The method of claim 1, wherein the clay additive comprises kaolin.

3. The method of claim 2, wherein the kaolin comprises from 2 to 30 weight percent of the coal.

4. The method of claim 1, wherein the slag additive comprises stainless steel slag.

5. The method of claim 4, wherein the stainless steel slag comprises from 2 to 30 weight percent of the coal.

6. The method of claim 1, wherein the clay additive comprises kaolin, the slag additive comprises stainless steel slag, and the combined total weight of the kaolin and the stainless steel slag comprises from 8 to 50 weight percent of the coal.

7. The method of claim 1, comprising combusting the coal in the presence of limestone in addition to the clay additive and the slag additive.

8. The method of claim 7, wherein the limestone comprises from 0.5 to 3 weight percent of the coal.

9. The method of claim 1, further comprising combusting the coal in the presence of water in addition to the clay additive and the slag additive.

10. The method of claim 9, wherein the water is combined with at least one of the clay additive and the slag additive to form a slurry prior to introduction to a combustion zone of the coal.

11. The method of claim 1, wherein the reduced emissions include at least one gas selected from NOₓ and SOₓ.

12. The method of claim 11, wherein NOₓ emissions are reduced by at least 10 percent.

13. The method of claim 11, wherein SOₓ emissions are reduced by at least 10 percent.

14. The method of claim 1, wherein the reduced emissions include mercury.

15. The method of claim 14, wherein the mercury emissions are reduced by at least 10 percent.

16. The method of claim 1, further comprising recovering a combustion product after the coal has been combusted in the presence of the clay additive and the slag additive.

17. The method of claim 16, wherein the combustion product comprises a pozzolanic cement additive material.

18. A combustion product produced by the method of claim 1, comprising a pozzolanic cement additive material.

19. A method of reducing emissions during coal combustion processes comprising combusting the coal in the presence of a kaolin additive and a stainless steel slag additive, wherein the combined weight of the kaolin additive and the stainless steel slag additive is from 2 to 60 weight percent of the weight of the coal.

20. The method of claim 19, wherein the combined weight of the kaolin additive and the stainless steel additive is greater than 8 weight percent of the coal.
